(19) United States
(12) Patent Application Publication
(10) Pub. No.: US 2012/0323787 A1
(43) Pub. Date: Dec. 20, 2012

(54) SYSTEMS AND METHODS FOR FIXED FORM CARD TO VIRTUAL CARD COMMUNICATION

(75) Inventor: David A. Nelsen, Lake Oswego, OR (US)

(73) Assignee: GIFTANGO CORPORATION, Portland, OR (US)

(21) Appl. No.: 13/525,062

(22) Filed: Jun. 15, 2012

Related U.S. Application Data
(60) Provisional application No. 61/498,487, filed on Jun. 17, 2011.

(51) Int. Cl. G06Q 20/40; G06Q 20/34

(52) U.S. Cl. 705/44

(57) ABSTRACT

System and methods for converting a fixed form card to a virtual card are disclosed herein. The system includes a virtual card manager and a user computing device communicatively coupled via a network. The virtual card manager may be configured to convert a fixed form card to a virtual card, and the user computing device may be configured to initiate a virtual card conversion request via a virtual card engine stored in mass storage and executable by a processor. As such, a stored value of the fixed form card may be transferred to the virtual card in a secure manner.

### CROSS REFERENCE TO RELATED APPLICATION

The present application claims the benefit of and priority to U.S. Provisional Application No. 61/498,487 filed Jun. 17, 2011 the content of which is incorporated herein by reference for all purposes.

### FIELD

The present disclosure relates generally to systems and methods for converting a fixed form card to a virtual card.

### BACKGROUND AND SUMMARY

Plastic gift cards, open loop payment, and debit cards, referred to herein as a fixed form card, have become a popular form of payment in today's marketplace. Consumers typically present the fixed form card, such as a plastic form, to a cashier at a brick and mortar location for redemption. However, payment systems continue to evolve in the market and the use of electronic and mobile forms of payment is increasing. Difficulties arise with the transition to mobile forms of payment due to issues related to security and fraud, tracking and redemption.

In regards to fixed form cards, there are many difficulties in managing a large number of plastic cards maintained by a consumer. Due to the number of these cards that a consumer may manage, consumers may physically stretch their wallets to carry the large number of cards and it may be difficult to locate a desired plastic card for use due to the number of cards. With the large number of plastic cards carried by consumers, the consumer may desire to reduce the number of cards that are carried in the physical wallet or purse. In one example, consumers may desire to create mobile versions of a wallet and carry virtual forms of payment electronically on a mobile device. Additionally, when the plastic cards are not carried for use, in some examples, a consumer may lose the plastic gift card or fail to bring the plastic gift card to the brick and mortar store for redemption resulting in frustration with plastic gift cards.

The issuance of a plastic card also increases the potential for loss or misplacement of the card. Furthermore, fraudulent use of cards may occur if the card is lost and then redeemed by a third party. The fraudulent use of the cards may negatively affect the card holder, goods and services system, and/or the card service provider as well as the industry as a whole. Further, issuance of plastic cards is also costly for the card issuer, and today's legal environment often necessitates constantly sending and resending new plastic to the consumer.

As the inventors herein have recognized the difficulties with the plastic-issued or fixed form cards, alternative methods and systems for electronic cards have been developed. These electronically-issued and managed cards are referred to herein as virtual cards. The virtual cards may include, but are not limited to, one or more of a virtual gift card, a virtual loyalty card, a virtual membership card, a virtual rewards card, a virtual debit card and a virtual credit card. Plastic, cardboard, paper or other tangible forms of payment cards are herein referred to as fixed form or traditional cards.

As described in more detail below, the Inventors herein have provided systems and methods for converting fixed form cards to virtual cards. In one embodiment a system for converting a fixed form card to a virtual card is provided. The system includes a user computing device having mass storage executable by a processor and including a virtual card engine stored thereon, the virtual card engine configured to receive fixed form card data, generate a virtual card in response to receiving the fixed form card data, send a fixed form card conversion request to a virtual card manager in response to receiving the fixed form card data, receive a conversion file including virtual card value data corresponding the value of the fixed form card from the virtual card manager upon authentication of the fixed form card data via the virtual card manager, and initiate a virtual card transaction with a card service provider.

When the fixed form card is converted to a virtual card, the security of the card can be increased. One technique which may be used to increase security of the virtual card may be to selectively disable the virtual card via the virtual card manager subsequent to conversion of the fixed form card to the virtual card. Selectively disabling the card may inhibit virtual card transactions from being implemented until it is determined that a virtual card transaction may be desired by a user. In this way, the likelihood of fraudulent use of the virtual card is decreased. Additional security measures that may be employed to increase the security of the virtual card are described in greater detail herein.

### BRIEF DESCRIPTION OF THE FIGURES

The disclosure is illustrated by way of example and not by way of limitation in the figures of the accompanying drawings, in which the like references indicate similar elements and in which:

FIG. 1 shows an example schematic of a virtual card management system according to an embodiment of the present disclosure.

FIGS. 2-3 show an example method for converting a fixed form card to a virtual card using the virtual card management system shown in FIG. 1.

FIGS. 4-13 show example screenshots that may be included in some embodiments of the virtual card management system shown in FIG. 1.

FIG. 14 illustrates an example method for encrypting data associated with the virtual card management system of FIG. 1.

FIG. 15 shows an example enablement module that may be included in some embodiments of the virtual card management system show in FIG. 1.

FIG. 16 shows an example virtual card manager that may be included in some embodiments of the virtual card management system shown in FIG. 1.

FIG. 17 shows an example virtual card engine that may be included in some embodiments of the virtual card management system shown in FIG. 1.

FIGS. 18-20 show a method for converting a fixed form card to a virtual card.

### DETAILED DESCRIPTION

As described in more detail below, systems and methods are provided for converting a fixed form card to a virtual card. Further, systems and methods have been developed to increase the security of a virtual card during the assignment of a virtual card from its previous fixed form state, such as a plastic state, in order to reduce the likelihood of fraudulent use of the virtual card.

As an example and not as a limitation, a virtual card manager may manage a plurality of third party systems, such as third party point of sale systems. Regardless of the type of third party system, the virtual card manager may enable conversion such that users may be able to selectively convert a fixed form plastic card to a virtual card. The virtual card management system may manage the conversion such that the third party system recognizes the converted virtual card as stored value cards in their system. Thus, the virtual card management system enables conversion of fixed form cards to virtual value cards and provides security to using the converted virtual value cards regardless of the setup of the third party system.

In some embodiments, the fixed form card is converted to a virtual card by capturing an image of the fixed form card with a mobile computing device. The image may include identifying features such as a two-dimensional barcode (also known as a QR code), that enable the virtual card manager to identify the fixed form card and transfer aspects of the fixed form card to a corresponding virtual card. For example, the virtual card manager may transfer stored value from the fixed form card to the corresponding virtual card; however it will be appreciated that other aspects of the fixed form card may be transferred to the virtual card. In this way, a fixed form card may be converted to a virtual card.

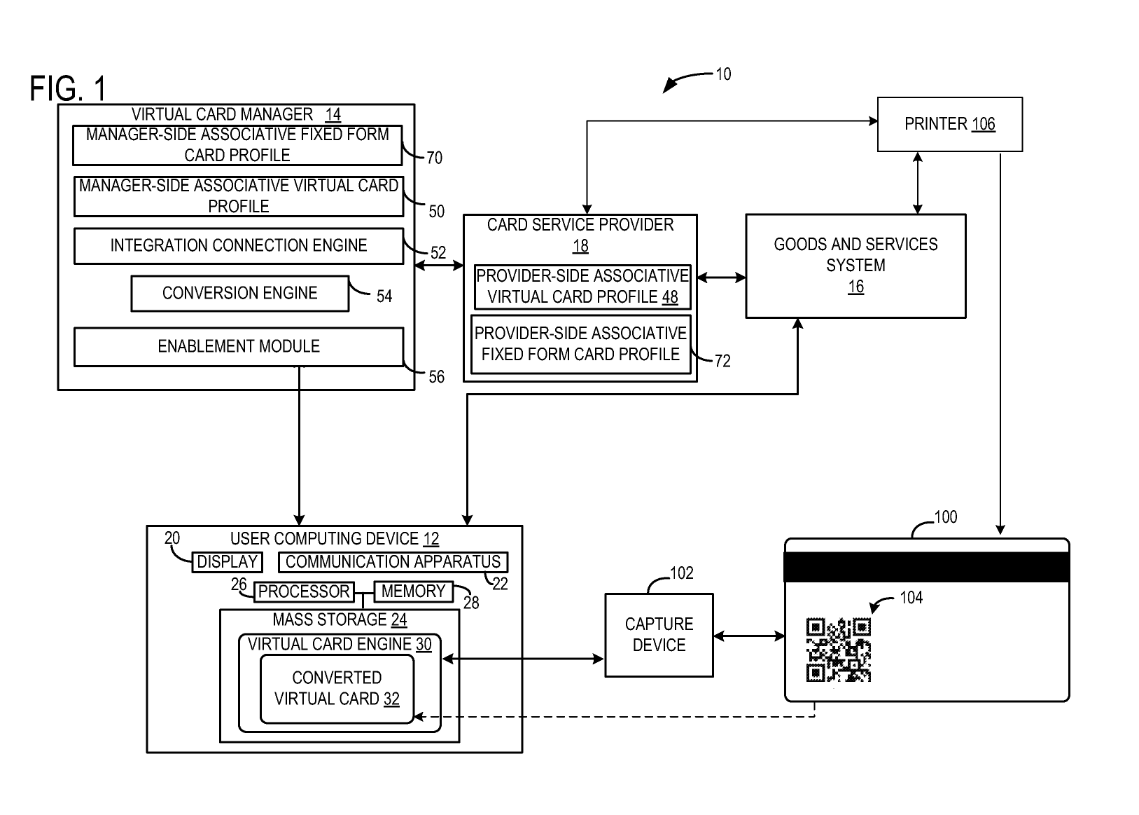

FIG. 1 shows an exemplary schematic illustration of a virtual card management system 10 according to an embodiment of the present disclosure. As described below, the system enables management and use of a converted virtual card.

Virtual card as used herein may be an electronically-issued and/or electronically maintained virtual value card. A virtual value may be any type of privilege, monetary or non-monetary. For example, a virtual value card may be a stored value card which may include, but is not limited to, a virtual gift card (such as an eGift card), a virtual loyalty card, a virtual rewards card, a prepaid card, or another suitable virtual card that holds prepaid value. The stored value card may have monetary or other forms of value stored on the virtual card. For example, the virtual card may be a monetary gift card to a specific merchant or group of merchants. In another example, a virtual value card may be a virtual membership card where such stored value includes membership privileges or identification-related privileges. An example of virtual membership cards may include, but are not limited to, virtual identification cards, club cards, promotional cards, identification cards (ID cards), etc. Depending on a merchant's business, a merchant may limit specific privileges to one or more types of virtual cards. For example, in some systems, a merchant may select to activate privileges only for virtual gift cards and not to virtual membership cards.

As depicted in FIG. 1, virtual card management system 10 may include a user computing device 12, a virtual card manager 14, at least one goods and services system 16, and in some systems, at least one card service provider 18. Virtual card management system 10 may be configured as a closed loop card management system, and/or an open loop card management system, for example.

The user computing device may be any suitable computing device that enables a user to store and maintain one or more virtual cards. For example, the user computing device may be a smart phone, a hand-held computing device, a mobile device, a laptop computer, a portable media player, a desktop computer, etc. In some embodiments, the user computing device may run an identifiable operating system's software and provide a standardized interface and platform for applications. The user computing device may be networked to one or more networks, such as a public network (e.g. the Internet), to enable communication between the user computing device and other elements included in the virtual card management system.

User computing device 12 may include a display 20 configured to present graphics on the device. The user computing device may also include a communication apparatus 22 facilitating wired and/or wireless communication between the user computing device and external systems and devices (e.g., the virtual card manager, the goods and services system, and the card service provider) such as through a network (not shown). As depicted, the user computing device 12 may include various software applications stored on mass storage 24 (e.g., a hard drive, solid state memory, a rewritable disc, etc.,) and executable via a processor 26 using portions of memory 28. The mass storage 24 may include various programmatic elements such as a virtual card engine 30 configured to manage one or more virtual card(s) 32. As described in more detail below, virtual card engine 30 may at least in part, convert a fixed form card to a virtual card for use on the user computing device. The virtual card engine 30 may be a software application configured to implement various virtual card functions, discussed in greater detail herein.

Further, and as described in more detail below, user computing device 12 may be configured to capture an image of a fixed form card 100. For example, the fixed form card may be a plastic gift card, debit card, credit card, rewards card, etc. The user computing device 12 may be operatively coupled to a capture device 102 (e.g., camera), wherein the capture device may relay an image of fixed form card 100 to the user computing device 12. It will be appreciated that the capture device 102 may be a component of the user computing device 12. For example, the user computing device 12 may be a mobile phone with image capture capabilities. Thus, the capture device may be integrated into the user computing device. Alternatively, the capture device may be external to the user computing device, and a capture image may be transferred to user computing device via a computer readable storage medium, for example.

As shown, fixed form card 100 may include a two-dimensional barcode 104. Printer 106 may print a fixed form card 100 including two-dimensional barcode 104, for distribution of stored value to customers. As such, printer 106 may be associated with or included in a card service provider and/or a goods and services system. As described in more detail below, two-dimensional barcode 104 may include encrypted data that allows the virtual card manager to identify and operably convert the fixed form card.

As shown, printer 106 may print a card number on a side (e.g., the back) of a plastic card. The card number may be encoded into a magnetic strip and/or the number may be encoded within a standard barcode. However, a magnetic strip and/or standard barcode alone do not impart security for converting a fixed form card to a virtual card on a mobile device. Security elements, such as a standard barcode, a two-dimensional barcode, or other identifier, may be used to facilitate communication between that fixed form card and the mobile device in order to enhance security.

In some embodiments, two-dimensional barcode 104 may be used to identify fixed form card 100. For example, the two-dimensional barcode may be any two-dimensional barcode well known in the art including but not limited to, PDF417, Data Matrix, maxiCode, EzCode, Aztec Code, and QR Code. In this way, capture device 102 may capture an image or scan two-dimensional barcode 104 to initiate the conversion of fixed form card 100 to a virtual card, such as converted virtual card 32.

It will be appreciated that there are various ways to communicate a card number to a computing device, and the use of two-dimensional barcodes is provided as one non-limiting example. These types of codes can handle larger amounts of data and are currently the most accepted methods to communicate with mobile computing devices. However, it is to be understood that other methods by which communication between fixed form cards and computing devices can occur are possible without departing from the scope of this disclosure. For example, methods may include wireless and other communication technologies between the fixed form card and the user computing device.

It will be appreciated that in some embodiments, a user may input other information pertaining to a fixed form card in order to identify a particular fixed form card. In this way, a user may convert a fixed form card to a virtual card without having to capture an image or scan an image of the fixed form card.

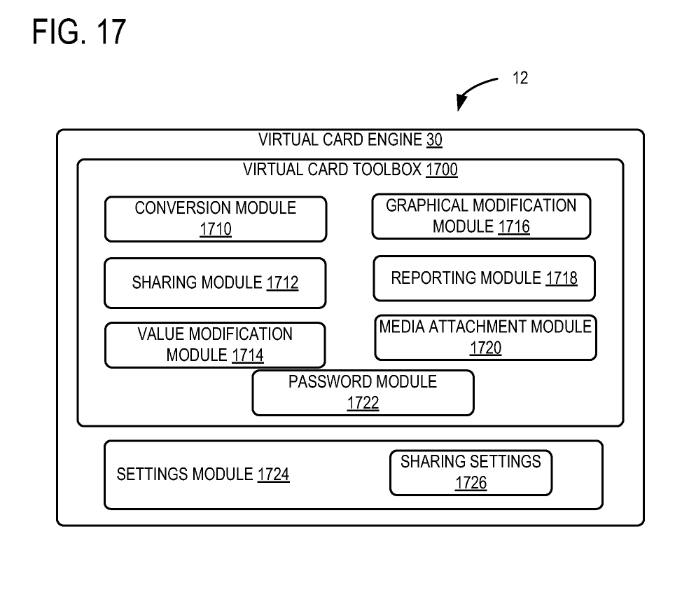

As introduced above, the user computing device 12 may include a virtual card engine 30. The virtual card engine 30 may be software applications configured to implement various virtual card functions to enable ease and use of virtual cards, such as converting fixed form cards to virtual cards. Some of the virtual card functions may be implemented via various modules. FIG. 17, described below, provides example modules of a virtual card engine which may be used to manage the virtual cards. Management may include managing the conversion of a fixed form card to a virtual card and tracking use of the converted virtual card.

It should be appreciated that in some embodiments, a browser-based virtual card engine may be utilized. In other words, the virtual card engine may be executed on a remote Internet server accessible via the user computing device. In some examples, when a browser-based virtual card engine is used, a card service provider or associated goods and services system may manage various characteristics of the virtual cards. Management of the characteristics and functions of the virtual cards may include tracking the converted virtual card or characteristics of the converted virtual card as made by a virtual card user. Limitations associated with the use of the converted virtual card or modifications to the characteristics of the converted virtual card may be managed by a virtual card manager. Such limitations may be based on selections or capabilities of a goods and services system and/or a card service provider.

A converted virtual card, as used herein, may be any virtual card that has been converted from a previous physical card and provides value that is accessible through one or more computing devices. As discussed above, a converted virtual card may be a virtual value card, such as virtual gift card or virtual membership card. Each virtual card may include one or more types of card data. Example card data, includes, but is not limited to identification (ID) number, a personal identification number (PIN), a stored value, a name, a barcode, image data (e.g., picture of a card holder or other image data), data corresponding to the associated goods and services system through which the card may be used, etc.

Continuing with FIG. 1, the goods and services system 16 (also referred to generally as the merchant) may be a system configured to manage goods and services transactions. The merchant may be a store or other commercial establishment selling or providing goods and/or services that desires to have their card data or stored value issued electronically or virtually through a mobile or other electronic device. In some examples, the merchants may include card service providers which may be a third party service or provider that represents a gift card or other card services on behalf of a select merchant. The card service providers may be third party stored value companies, a module or software component of the merchant's existing Point of Sale (POS) software and/or provider, and/or application or software purchased, created, or used by the merchant to track the virtual card services on behalf of the merchant.

In some examples, the goods and services system 16 may be configured to virtually or electronically issue card data such as loyalty data, membership data, value data (e.g. monetary data), etc., through a computing device or other electronic device. The goods and services system may include a POS system which may include software and hardware to manage electronic transactions. It will be appreciated that the goods and services system 16 may be associated with one or more merchant outlets. Example merchant outlets may include one or more commercial establishments or businesses, including brick and mortar stores, such as coffee shops, restaurants, hotels, supermarkets, bookstores, toy stores, etc. As provided herein, the goods and services system 16 may process a virtual card transaction at a brick and mortar location, in some examples. However, in other examples, the goods and services system 16 may process a virtual card transaction over the Internet or other similar network.

One type of exemplary transaction may include an electronic transaction, such as a virtual card transaction. A virtual card transaction may include communication between two systems, devices, etc., in which value and/or privilege data is exchanged and/or manipulated. For example, a virtual card transaction may include deducting value from a virtual card in exchange for a good or service at a merchant location associated with a goods and services system. Further, in other examples, a virtual card transaction may include, scanning or otherwise communicating (e.g. NFC—Near Field Communication) a virtual membership card at a merchant location associated with a goods and services system and granting access privileges to the merchant location. Further, it will be appreciated that in some examples a transaction may include implementation of security protocols.

In some embodiments, the goods and services system 16 may directly manage and control virtual card transactions. In such examples, card service provider 18 may be included in the goods and services system 16. However, in other examples, the goods and services system may use an external card service provider.

Thus, a third party card service provider may be used in some embodiments. The card service provider 18 and the goods and services system 16 may be configured to manage fixed form card service and virtual card services. The card services may include adjusting the value of the fixed form or virtual card. Specifically, the card service provider may enable the goods and services system to perform virtual card transactions. As an example, the third party card service provider may be the software and hardware configured to perform virtual card transactions on behalf of a selected goods and services system. For example, the third party card service provider may include both hardware and software which, among other things, may be configured to electronically process virtual card transactions. It will be appreciated that virtual card transactions may include value transactions, such as monetary transactions in which value of a virtual card is adjusted. Additionally, the virtual card transactions may also include management of electronic privileges (e.g. card holder privileges) such as electronic access to certain types of data.

As mentioned above, card service provider 18 may be a third party stored value system or a module or software component of the goods and services system's existing POS system created or used by the goods and services system to track the virtual card services on behalf of the goods and services system. A goods and services system's POS Provider may be software, hardware, and/or other devices configured to process goods and services transactions at a location. Often times the POS may have a module or built in capability, thus making the POS System also a “Card Service Provider”.

Card service provider 18 may be configured to generate at least one provider-side associative virtual card profile 48, each associative card profile corresponding to a converted virtual card. The card service provider 18 may also include at least one provider-side associative fixed form card profile 72 corresponding to a fixed form card. Furthermore, the provider-side associative fixed form card profile 72 may include value data and identification data associated with the fixed form card. The provider-side associative virtual card profile 48 and/or the manager-side associative fixed form card profile 72 may be stored in a provider-side database. The provider-side associative card profile may include virtual card data such as stored value (e.g. monetary value, point value), identification (ID) data {e.g. ID number, personal identification numbers (PINs)}, a card holder's name, etc. A selected provider-side associative card profile may be accessed and adjusted during a virtual card transaction. It will be appreciated that the provider-side associative card profile may be included in the goods and services system, in some embodiments.

Referring again to FIG. 1, a virtual card manager 14 may include at least one manager-side associative virtual card profile 50, an integration connection engine 52 and an enablement module 56. As illustrated, virtual card manager 14 may be communicatively linked with one or more of the user computing device 12, and/or the card service provider 18 or the goods and services system 16. Additionally, the virtual card manager may include at least one manager-side associative fixed form card profile 70 corresponding to a fixed form card. The manager-side associative fixed form card profile 70 may include value data and identification data associated with the fixed form card. However, in other embodiments the virtual card manager 14 may not include the manager-side associative fixed form card profile 70. The manager-side associative virtual card profile 50 and/or the manager-side associative fixed form card profile 70 may be stored in a manager-side database. Furthermore, it will be appreciated that in some embodiments the virtual card manager may also be communicatively linked with goods and services system 16. As such, virtual card manager 14 may be configured to manage a plurality of converted virtual cards.

In other words, virtual card manager 14 may be a universal virtual card manager configured to communicate with virtually any system associated with card service provider 18 and/or goods and services system 16. In this way, virtual card manager 14 is configured to manage multiple merchants which may each operate with their own systems and processors. Therefore, the virtual card manager 14 leverages a single stored value account with any third party processor. For example, a third party processor may be a processor associated with a card service provider and/or a goods and services system. In this way, the virtual card manager 14 operates on a level above any third party processor to manage converted virtual cards within an infrastructure of the virtual card manager 14. As such, the virtual card manager 14 may create virtually any number of converted virtual cards across a single account. Further, as stated above, the virtual card manager 14 may manage use of the converted virtual cards and across any third party processor because the virtual card manager 14 operates on a higher level than a card service provider and/or a goods and services system. As such, the virtual card manager 14 is universal because it is configured to translate any processor language to convert a fixed form card to a virtual card, authenticate use of the converted virtual card, and selectively enable the converted virtual card for a transaction, as described in more detail below.

The manager-side associative virtual card profile 50 may also include virtual card data such as stored value (e.g., monetary value, point value), identification (ID) data {e.g., ID number, personal identification numbers (PINs)}, a card holder name, etc. The provider-side associative virtual card profile 48 and manager-side associative virtual card profile 50 may be accessed and adjusted during a virtual card transaction.

To further provide an illustration of an example method, in one example in regards to FIG. 1, a converted virtual card may be delivered to a user through a computing device, such as a stationary computing device or a mobile computing device. The virtual card may be delivered for use on a user's computing device (e.g. user computing device 12). Predetermined authentication rules, also referred to as security rules, may be associated with the virtual card. The authentication rules may be implemented such that the state of the virtual card (e.g. enabled state, disabled state, etc.) may be managed by the virtual card manager. In some systems, the virtual card manager may be a remote server while in other systems the virtual card manager may be on the computing device.

As an example, depending on the authentication rules, use of the virtual card may be limited to an identified computing device such that an attempt to use the virtual card from an unidentified (unassociated) computing device is blocked. When such a use is requested, the virtual card may remain in a disabled state, thereby preventing the unauthorized use of the card. Again, depending on the rule set, in some systems, a merchant may be able to over-ride the disabled state if additional identification is provided. Although the above example is described in regards to identification of a single computing device, in some examples, a user may be able to introduce additional computing devices as authorized computing devices. In such systems, the rule set may enable identification of a requesting computing device as an authorized computing device such that the state of the card is enabled.

Although only a single card service provider and computing device are depicted, it will be appreciated that virtual card manager 14 may act as a common platform for managing a large number of virtual cards corresponding to a plurality of card service providers. In some examples, two or more of the card service providers may have different characteristics. For example, two or more of the card service providers may utilize different communication protocols and may be linked to different goods and services systems and therefore provide different services. Furthermore, the card service provider may provide different types of card services. For example, one card service provider may provide membership card services while another card service provider may provide gift card services. In this way, a single virtual card management system can be used to manage a large number of virtual cards, facilitating scalability of the virtual card management system, thereby enhancing the market appeal of the virtual card management system.

Continuing with FIG. 1, in addition to the manager-side associate card profile and the enablement module, in some examples, the virtual card manager may include an integration connection engine 52 configured to communicatively link the virtual card manager with at least one card service provider 18 (and/or a goods and services system) via an API or other software communication standard included in the card service provider. In this way, the virtual card manager may communicate with the card service provider. When a plurality of card service providers are communicatively linked to the virtual card manager at least a portion of the card service providers may utilize different communication protocols, communication hardware, security protocols, etc. Thus, the integration connection engine may enable the virtual card manager to interact with a number of different card service providers. In other embodiments, the card service provider may wish to use an API or other software provided by the virtual card manager to enable communication. In further examples, the card service provider may include other methods or systems for communicating with the virtual card manager. Additionally, it will be appreciated that in some systems, the integration connection engine may include one or more virtual card adapters configured to modify the data sent/or received into a common programming language, such as XML.

Virtual card manager 14 also may, amongst other functions, provide for management of a converted virtual card. For example, virtual card manager 14 may include a conversion engine 54. It should be appreciated that conversion engine 54 may be integrated such that it accesses one or more of the manager-side associative virtual card profile 50, the integration connection engine 52, and/or enablement module 56. Further, it should be appreciated that the conversion engine may be part of at least one of these components, such as part of the virtual card manager and/or reside in whole or in part on one or more of the user computing device, the card service provider, or the goods and services system.

Conversion engine 54 may be communicatively and operatively linked with the integration connection engine, the enablement module and/or the manager-side associative card profile in some embodiments. Further, the conversion engine may be communicatively and operatively linked to one or more modules which may reside on or be linked to one or more of the components of virtual card manager 14. For example, the conversion engine may be linked to modules, such as tracking module 1600, administrative module 1602, reporting module 160404, etc. which are described in more detail below with reference to FIG. 16.

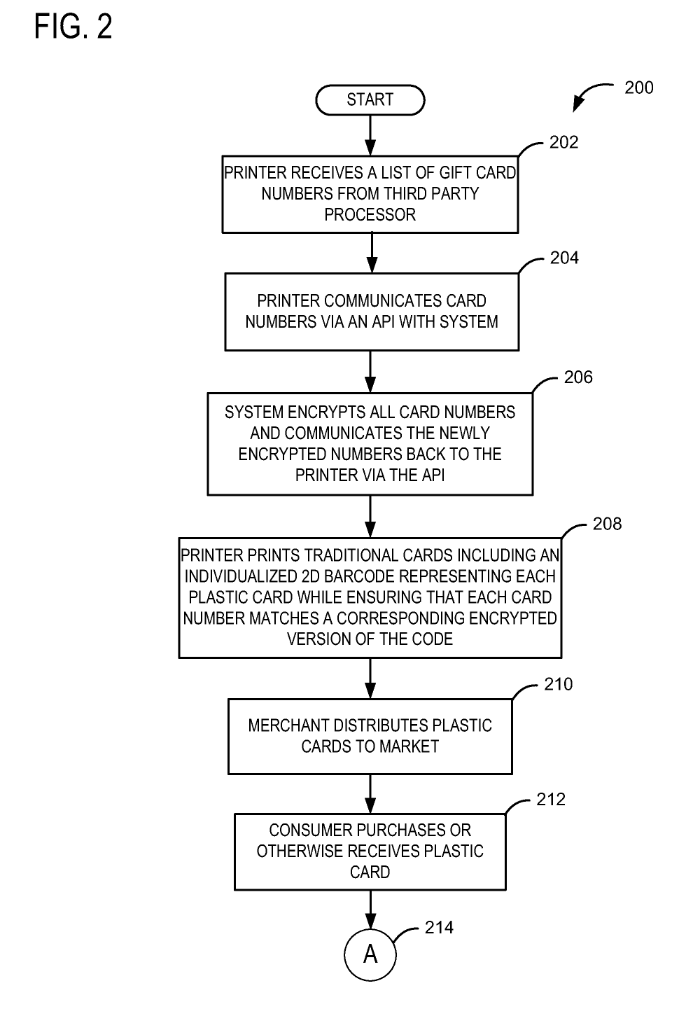

Turning now to FIG. 2, an example method 200 for converting a fixed form card to a virtual card according to an embodiment of the present disclosure is provided. The method may be implemented via the virtual card manager 14, the card service provider 18, the user computing device 12 and/or a goods and services system 16. It should be appreciated that the method may be implemented in whole or in part by other system components, including the virtual card engine of the user computing device, the goods and service system, etc. Further, in other embodiments, method 200 may be implemented by other suitable systems, modules, components, etc.

At 202, method 200 includes a printer receiving a list of gift card numbers from a third party processor. For example, a card service provider and/or a goods and services system may be associated with a printer 106 that prints plastic fixed form cards for distribution to customers. At 204, method 200 includes the printer communicating card numbers to a virtual card management system via an API. For example, the printer may communicate the card numbers to virtual card management system 10 via an API supported by the virtual card manager 14 of FIG. 1. Thus, the printer may call the virtual card manager to grab an encrypted code to place into the two-dimensional Barcode for printing.

At 206, method 200 includes encrypting the card numbers and sending the encrypted card numbers back to the printer via the API. For example, virtual card manager 14 may encrypt the card numbers and send the encrypted card numbers back to the printer.

At 208, method 200 includes the printing the fixed form cards including an individualized two-dimensional barcode, such as two-dimensional barcode 104 of FIG. 1. In this way, each two-dimensional barcode is representative of a specific fixed form card such that the two-dimensional barcode identifies the fixed form card. Further, the two-dimensional barcode may include identifying information that links the fixed form card to a specific encrypted card number that may be used for future conversion of the fixed form card to a converted virtual card. In this way, the converted virtual card is linked to the fixed form card via the two-dimensional barcode. Further still, since the encrypted card numbers have been sent back to the printer, a manufacturer of the printed fixed form cards is able to cross reference the actual card number with the encrypted version of that card number. The double check confirms the accuracy of the printed code. Thus, security of distributing fixed form cards with two-dimensional barcodes is enhanced.

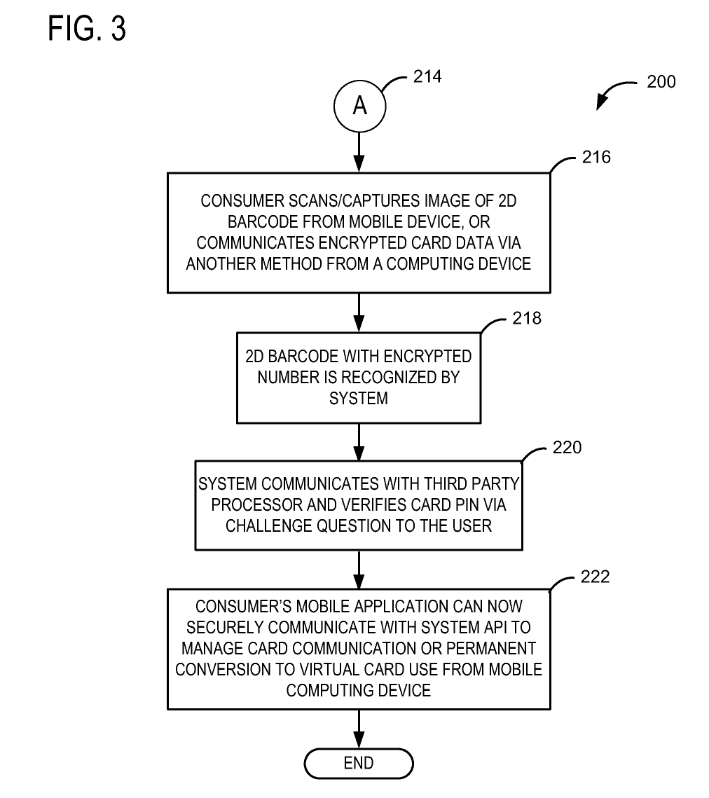

At 210, method 200 includes the merchant distributing the plastic fixed form cards to the market for consumer to purchase. At 212, method 200 includes a consumer purchasing a fixed form card. At 214, method 200 continues to FIG. 3.

At 216, method 200 includes the consumer scanning or capturing an image of the two-dimensional barcode. For example, a user may use a camera of a mobile computing device to capture an image of the two-dimensional barcode, as described above. Alternatively, the consumer may communicate the encrypted data associated with the fixed form card using other methods. For example, the user may enter a card numbers associated with the fixed form card, and may be further prompted to answer one or more challenge questions that may be used to further identify the fixed form card and/or the user.

At 218, method 200 includes the virtual card manager receiving the encrypted card data. The virtual card manager may perform a matching operation to associate the fixed form card to a virtual card profile via the encrypted card data. At 220, method 200 includes the virtual card manager communicating with a third party processor associated with the fixed form card, to verify the fixed form card. For example, the fixed form card may be verified by a user successfully entering a PIN and/or one or more challenge questions associated with the fixed form card. The PIN code may be a code on the back side of a fixed form card, for example. The PIN code may be used as a cross reference to ensure that the user claiming to have a particular fixed form card does indeed possess the physical card. The PIN may also be leveraged by the virtual card manager and/or virtual card engine of the user computing device as cross reference to the encrypted code sent to that manager/engine referencing the fixed form card.

At 222, method 200 includes communicatively linking a user computing device to the virtual card manager via the API. For example, communicatively linking may include generating a converted virtual card that was previously associated with a specific fixed form card. Further, communicatively linking may allow a user to manage the converted virtual card. In this way, a user may present the converted virtual card on their computing device, such as their mobile device, for a transaction.

For example, by communicatively linking the fixed form card to a mobile computing device, two-dimensional barcode software may be leveraged in order to take or scan a picture of the two-dimensional barcode into their device, as described above. As such, the virtual card manager may be called from applications that may include browser based applications, applications residing on the mobile device, or applications residing on alternate servers (e.g. cloud computing), etc.

Communicatively linking may further include the virtual card engine decrypting the communicated code, requesting the user to communicate the associated PIN code, and then communicating the card number with the third party processor to communicatively link the virtual communications engine with the third party processing system. Further, the virtual card engine may verify if the user wishes to convert the plastic stored value card to a digital version of that card. As an example and not as a limitation, and as described in more detail below, periodic authentication (selectively enabling and disabling the card) principles may be used to offer security on the digital version of the card and request the user to discard the plastic fixed form card. As another example, additionally or alternatively, the virtual card manager may be configured to retrieve a new number from the processor, transfer funds to the new card number representative of the digital version and then employ periodic authentication elements to the digital card. Other systems may further be used to enhance the security of the converted card.

In some examples, the card service provider and/or the goods and service system may identify whether a card being used is a virtual card or a fixed form card. The virtual card manager or engine may further track the state of the card and toggle the type of card between the virtual card and the fixed form card such that the desired card and the stored value is available for use. The virtual card manager may employ security on when to toggle the switch between the virtual and fixed form cards and secure the stored value such that the stored value is available only for the toggled card. For example, periodic authentication, described in more detail herein, or other security method may be applied. Such monitoring and switching abilities may depend on the capability of the third party card service provider or processor. Thus, depending on the capabilities of the third party card service provider or processor to identify virtual and fixed form cards, the virtual card engine may enable use of one or both of a converted virtual card and/or a fixed form card and provide tags for the third party card service provider to identify the virtual and the fixed form card. Further, in some systems, the virtual card manager may enable transfer of value from the virtual and fixed form card.

In some embodiments, the user may select to continue to use the fixed form card as a form of payment without converting the fixed form card to a permanent virtual card. In this way, the user may be able to access an account associated with the fixed form card in order to manage aspects of the fixed form card through the user computing device.

For example, other functionality may be provided to leverage the secure communication layer between the fixed form card and a supported mobile application that recognizes and authenticates against the code for fixed form card. As a non-limiting example, daily deals or other promotions may be offered to a card holder based on the stored value or content of the virtual card. Example non-limiting promotions and options which may be activated through the system from checking the two-dimensional barcode include coupon and buy-one-get-one free promotions, options to enable increasing or topping up the card value, options to split card value with another card or account, options to converge card value between multiple cards, options to re-gift the card and other functionality.

It will be appreciated that method 200 is provided by way of example and may include additional or alternative steps than those shown in FIGS. 2 and 3. For example, fixed form cards may be printed with other forms of communication, additionally or alternatively, to a barcode, such as the two-dimensional barcode. For example, fixed form cards may be printed with wirelessly encoded technology representing the digitally encrypted version of the fixed form card or other identifier or code system.

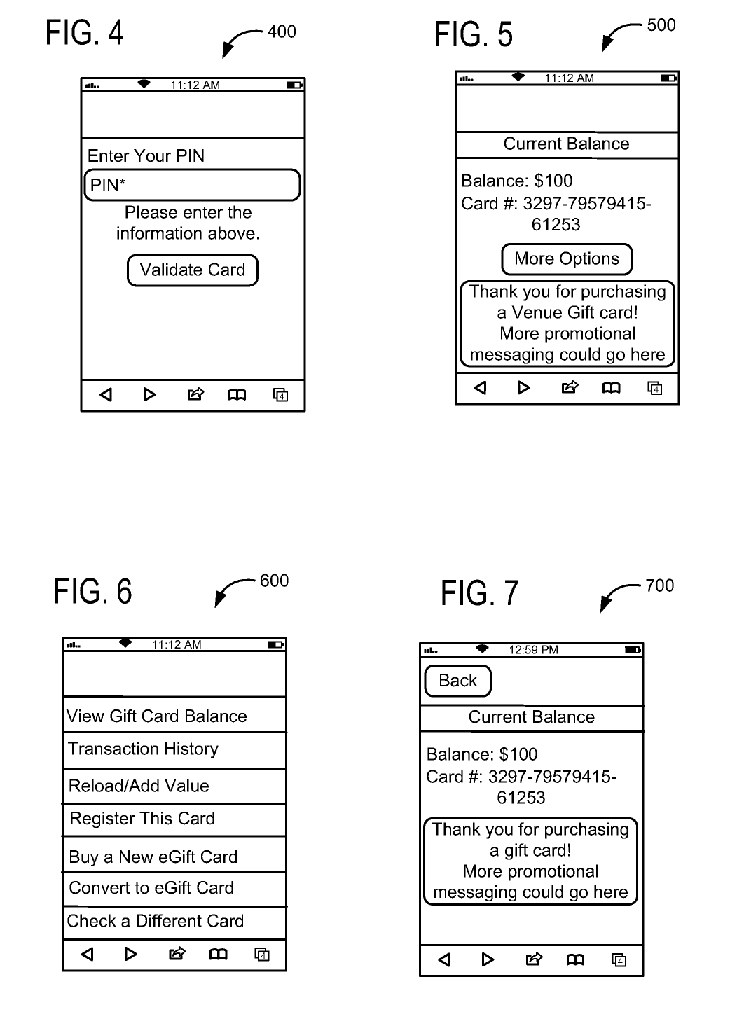

FIGS. 4-13 show example screenshots that may be displayed on a user computing device, such as a mobile device, including but not limited to a smart phone, a hand-held computing device, etc. Each screenshot may be a graphical user interface (GUI) for a user to interact with various features of the virtual card system. For example, each interface may allow a user to convert a fixed form card to a virtual card, check a virtual card balance, view transaction history, reload a virtual card with value, register a virtual card, purchase a new virtual card, etc.

FIG. 4 shows an example GUI 400 that may be displayed after scanning or otherwise entering a code of a fixed form card, wherein scanning or otherwise entering the code is provided as input for a user computing device. As shown, GUI 400 may include features that allow a user to enter a PIN number to validate the fixed form card to a virtual card via user selection of a virtual element.

FIG. 5 shows an example GUI 500 that may be a home page displayed on the user computing device. As shown, the home page may include a balance associated with a particular virtual card, a card number, a promotional message, and/or a virtual element allowing a user to access more options through another GUI linked to GUI 500 following user selection of the virtual element.

FIG. 6 shows an example GUI 600 that may include a list of features or options available to the user. In this way, a user may define and/or adjust various aspects of a virtual card. For example, a user may view a gift card balance, view transaction history, reload/add value to a virtual card, register a new virtual card, buy a new virtual card, convert a fixed form card to a virtual card, check features associated with another virtual card, etc. Availability of such features to a user may be customizable by a goods and services system, a card service provider and/or a virtual card manager.

FIG. 7 shows an example GUI 700 displaying a current balance of a particular virtual card, wherein the current balance is an indication of the current stored value of the particular card number. As shown, GUI 700 may further include a promotional message. In some examples, the promotional message may be selected based on the user's activities. In other examples, use or conversion of the card to a virtual card may trigger display of a promotional message.

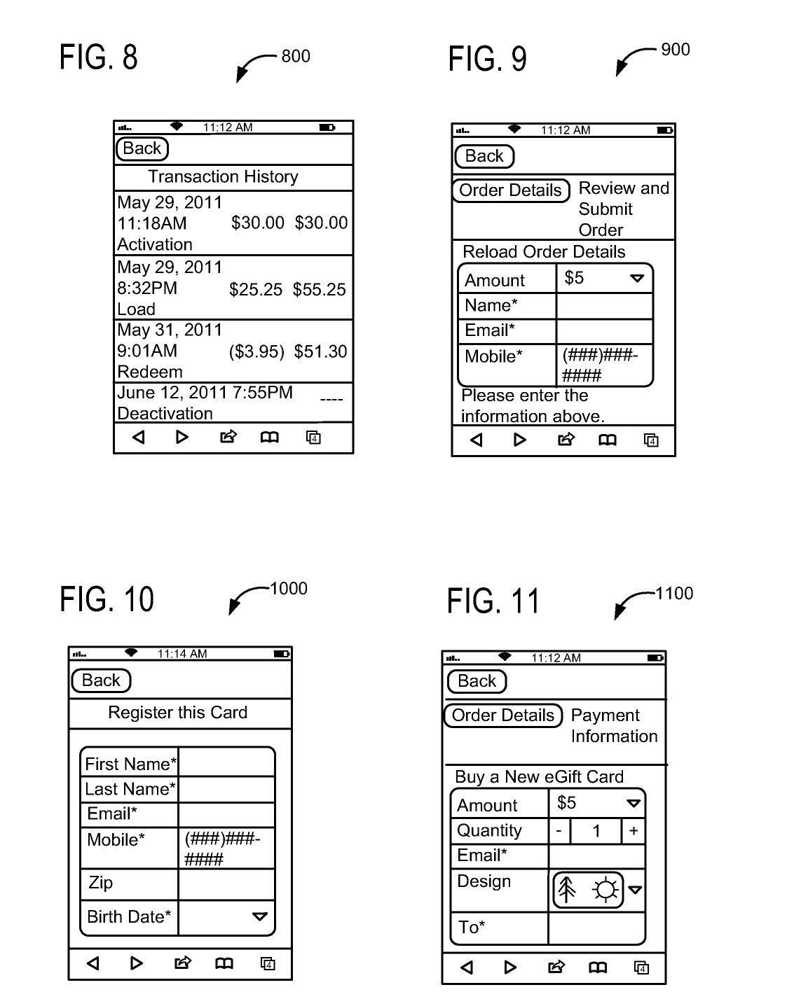

FIG. 8 shows an example GUI 800 displaying a transaction history of a particular virtual card. For example, the transaction history may include a date, a time, a description, an amount of a transaction, a running balance, etc. The transaction history may include additional information, including date, time, place of redemption, expiration information, etc. and other information associated with a particular virtual card.

FIG. 9 shows an example GUI 900 displaying options for reloading a virtual card with additional stored value. As shown, GUI 900 may include one or more fields for a user to input details in order to reload or increase the value of the virtual card. For example, a user may enter an amount, a name, an email, a mobile phone number, etc. In this way, a user may add value to a converted virtual card.

FIG. 10 shows an example GUI 1000 that may be displayed to allow a user to register a virtual card. As shown, GUI 1000 may include one or more fields for a user to input details in order to register the virtual card. For example, a user may enter a first name, a last name, an email, a mobile phone number, a zip code, a birth date, etc. Additionally, a user may opt to receive special offers associated with the virtual card. For example, a goods and services system may distribute special offers to users that select a box indicating a desire to receive special offers.

FIG. 11 shows an example GUI 1100 that may be displayed to allow a user to purchase a new virtual card. As shown, GUI 1100 may include one or more fields for a user to input details in order to purchase a new virtual card. For example, a user may enter an amount, a quantity of virtual cards, a design that may be associated with the virtual card, information identifying the recipient, etc. For example, a user may desire to purchase a virtual card and send the virtual card to a friend or family member.

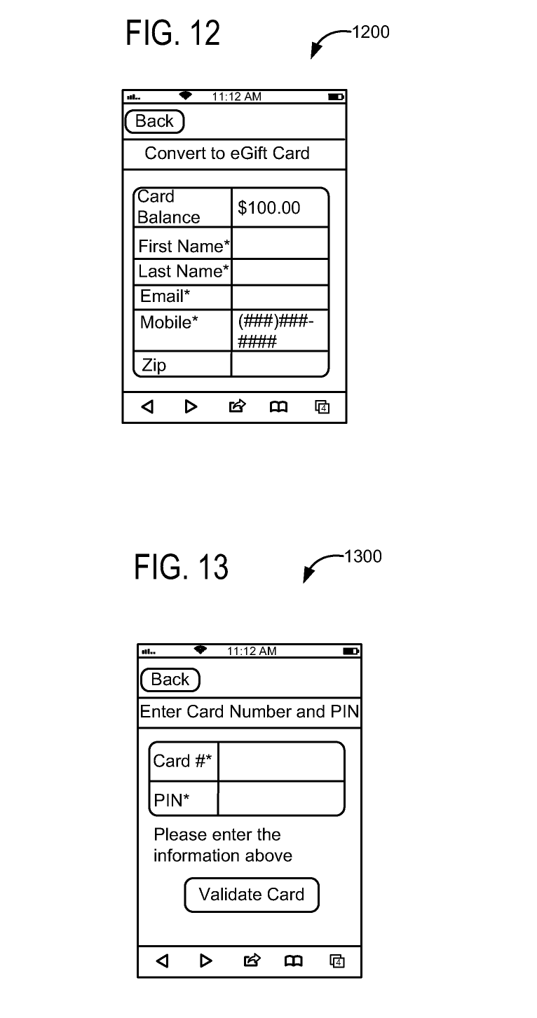

FIG. 12 shows an example GUI 1200 that may be displayed to allow a user to convert a fixed form card, such as a plastic card, to a virtual card, for example. In this way, a user may transfer the balance of stored value on the plastic card to a virtual card. Converting a plastic card to a virtual card may include sending the converted virtual card to an email account associated with the user and/or to a mobile device recognized as belonging to the user. As shown, GUI 1200 may include one or more fields for a user to input details in order to convert the plastic card to the virtual card. For example, a user may enter a first name, a last name, an email address, a mobile phone number, a zip code, etc.

FIG. 13 shows an example GUI 1300 that may be displayed to allow a user to check a different virtual card. As shown, GUI 1300 may include one or more fields for a user to input details in order to check various features of a virtual card. For example, a user may enter a card number and a PIN to identify a particular virtual card following selection of a virtual element to validate the virtual card based on the card number and the PIN entered by the user.

It will be appreciated that the GUIs provided in FIGS. 4-13 are examples and as such are not intended to be limited by the features shown in the drawings. Instead, FIGS. 4-13 illustrate a general concept and provide examples of a user interacting with the virtual card management system through input received from a user computing device. Other features and GUIs are possible without departing from the scope of this disclosure.

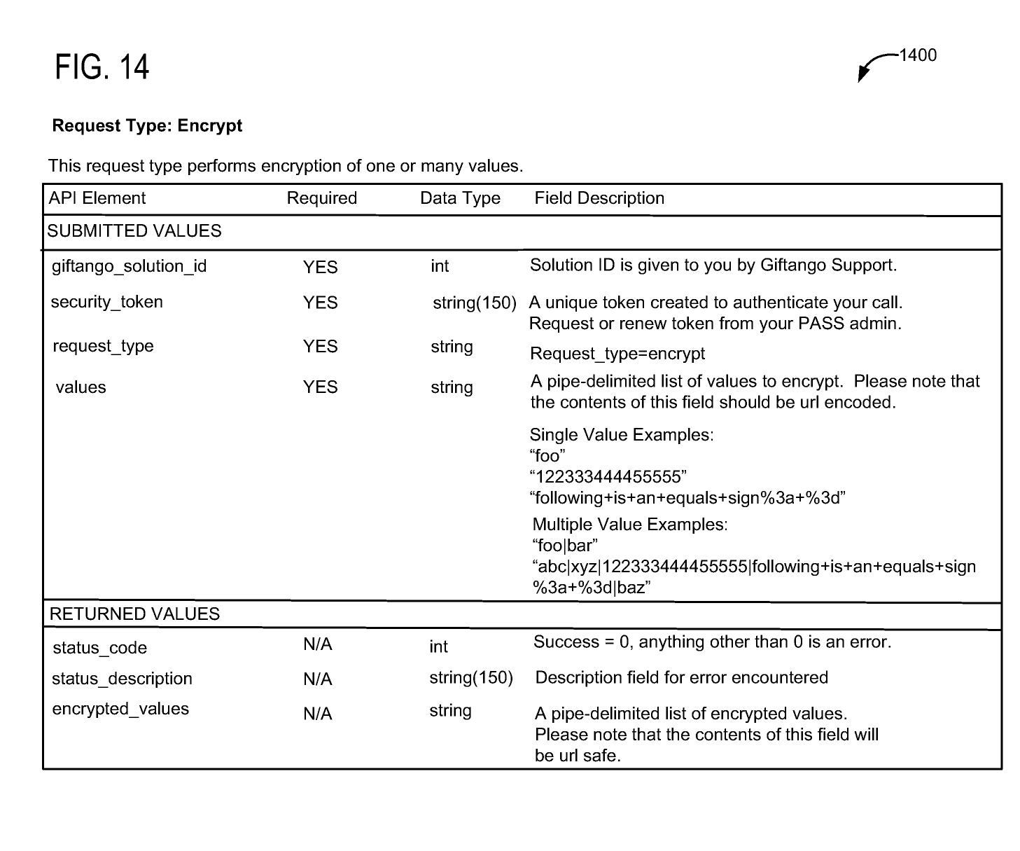

FIG. 14 shows an example encryption method 1400 that may be used to encrypt card numbers associated with a fixed form card. As described above, encrypted data may be included in a two-dimensional barcode or other code associated with the fixed form card. Method 1400 may be implemented by virtual card manager 14, virtual card engine 30, and/or another component of virtual card management system 10 of FIG. 1. It will be appreciated that method 1400 is provided by way of example and thus is not meant to be limiting. As such, other encryption methods are possible without departing from the scope of this disclosure.

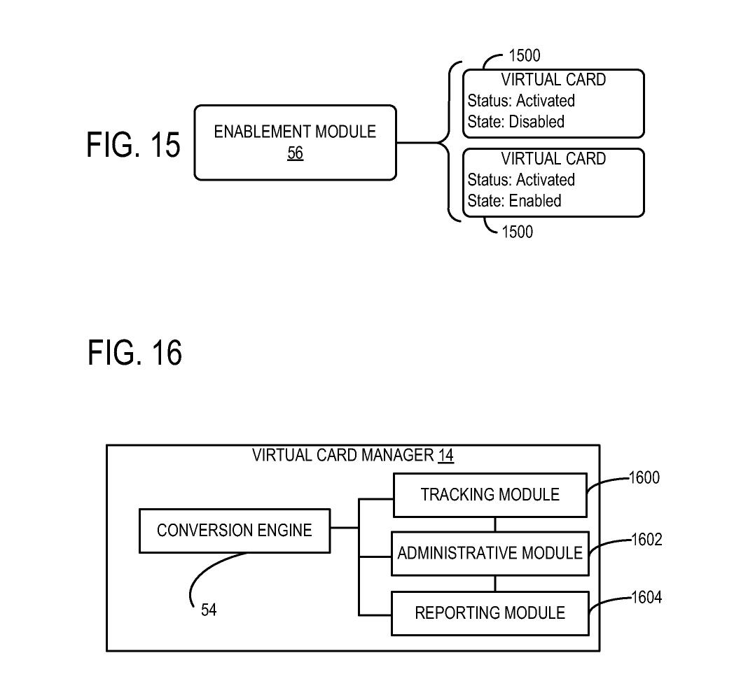

In addition, the virtual card manager 14, shown in FIG. 1, may be configured to manage various security features of the converted virtual cards such as selective enablement (e.g., access control via authentication). Example security features of a virtual card manager are disclosed in U.S. application Ser. No. 12/554,792 filed Sep. 4, 2009 entitled SYSTEMS AND METHODS FOR AUTHENTICATION OF A VIRTUAL STORED VALUE CARD, inventor David A. Nelsen. The disclosure of which is hereby incorporated by reference for all purposes. FIG. 15 is described in more detail below and illustrates an example enablement module that may be configured to manage various security features such as selective enablement.

FIG. 15 shows an example enablement module 56 that may be included as a component of virtual card manager 14 of FIG. 1. Enablement module 56 may be configured to manage various security features of the converted virtual cards such as selective enablement (e.g., access control via authentication). For example, use of a virtual card may be selectively enabled (e.g., enabled or disabled). It will be appreciated that the virtual card may have an “activated” status while the virtual card is selectively enabled. Thus, the virtual card may be “activated” but in an enabled or disabled state. Only when the card is activated and enabled is the value available for use/redemption. By using a periodic authentication and selective enablement system, use of the virtual card may be quickly turned “on” and “off” without deactivating the virtual card, thereby enhancing the security of the virtual card when compared to plastic gift cards which remain in an enabled state subsequent to activation. In other words, an activated virtual card may be first validated by the periodic authentication feature of the system, and then enabled for a period of time coinciding with a virtual card transaction. In this way, use of the stored value of the virtual card is disabled immediately before and after the virtual card transaction by the selective enablement feature of the system. It will be appreciated that periodic authentication and selective enablement may occur automatically when a user attempts to use a virtual card for a transaction, without the user needing to take additional steps in order to validate and enable the virtual card for a transaction.

As an example, a user may select the virtual card on a display of a mobile computing device through touch interaction. Once the virtual card has been selected, the virtual card may be automatically authenticated as a valid virtual card. For example, since the virtual card is linked to the user's computing device, the virtual card manager validates the relationship between the virtual card and the computing device, and if the relationship is recognized as valid, the enablement module may automatically toggle the virtual card from the disabled state to the enabled state. In this way, the user may “open” the virtual card for use by selecting the card on their display, and through such action the card may be automatically enabled, although only temporarily in some situations, if the relationship as described above is valid.

Since the virtual card is linked to a computing device an account number associated with the virtual card is secure. In other words, the account number alone cannot be entered for a transaction; the virtual card may be identified as linked to the computing device in order to be enabled for a transaction. Therefore, fraudulent use of the virtual card is reduced as the account number cannot be recorded and used by an unauthorized individual. It will be appreciated that the virtual card may be linked to more than one computing device such that the virtual card may be validated through periodic authentication on any one of the linked computing devices, and thus enabled for a virtual card transaction on any one of the linked computing devices.

It is to be understood that use of the phrase “periodic authentication” as used herein describes a specific period of time coinciding with a virtual card transaction, in which the virtual card is validated as an authentic card for use on a particular computing device. Therefore, “periodic” as used herein is not intended to describe randomly authenticating a virtual card. However, it will be appreciated that some embodiments may include random periodic authentication.

It will be appreciated that selective enablement may include features for a user to confirm or otherwise initiate the toggling of the virtual card to the enabled state and/or disabled state. Such features may be customizable by a user. Although described in regards to a selective enablement system, other security systems may be used to provide security to a virtual card transaction without departing from the scope of this disclosure.

Thus, in some examples, a virtual card system may be set up such that a virtual card manager is capable of enabling and disabling a virtual card. A merchant may be communicatively linked to the virtual card manager. The merchant may be able to select a level of security and/or fraud protection. Depending on the security level, a rule set may be applied for virtual cards associated with the merchant. The rule set may be applied with use of virtual cards associated with the merchant.

Turing back to FIG. 15, enablement module 56 may set or enable triggering of a virtual card 1500, for example a converted virtual card, between an enabled or disabled state. However, the virtual card may have an “activated” status. Thus, use of the virtual card may be quickly turned “on” and “off” without modifying the status of the virtual card (e.g., deactivating). The activated status of the card may indicate that the card is available for use, such that there is stored value on the card that is available for use. In some examples, where the virtual card is a virtual membership card, an activated card may be a card that is issued and the value in terms of privilege value is available.

It should be appreciated that enablement and disablement may be effectuated in many ways without departing from the scope of the disclosure. Such examples of enablement and disablement are provided for exemplary purposes and are not intended as limitations. Thus, in some examples, the enablement module may not affect the stored value on the card, but instead manages the usability of the card. That said, it should be noted that in some systems, a method of disablement may include temporarily removing the privilege or stored value on the card at the Card Service Provider, by storing that privilege with the virtual card manager until just prior to use. In some examples, a card may be disabled by removing the value on the card and holding that value in the Manager-side associative card profile. The value may be added back to the Provider-side associative card profile at the last moment prior to use. In such systems, the card may be enabled and disabled with the card service provider without inactivating the card.

As an example, FIG. 16 shows tracking module 1600 which may be configured to track and record information corresponding to the creation of a converted virtual card. The information may include the number of virtual cards that have been converted, the use of the converted virtual card, information pertaining to the associated virtual value account, etc.

In addition to tracking the converted value cards, statistical information may be tracked including data such as the percentage of virtual cards that have been converted, the frequency of converting, and other information regarding use of the conversion function for a specific goods and services system. In some examples, the merchant may access a tracking report documenting the aforementioned information via a computing device. In this way, a merchant may access statistical information about the converted virtual cards and use of the converted virtual cards.

The virtual card manager may further include an administrative module 1602 configured to manage the functionalities assigned to converted virtual card administered by the virtual card manager. Additionally, the administration module may be configured to manager various fraud and security elements for each card administered by the virtual card manager.

The virtual card manager may further include a reporting module 1604 configured to report the tracking data and/or administrative data in response to a request to view such data. For example, the reporting module may be configured to provide data reports to a goods and services system so that a merchant may gather statistics associated with users of the merchant's shared virtual cards. However, it will be appreciated that data reports may be provided to virtually any system in communication with the virtual card manager. In another example, the reporting module may be configured to provide tracking data reports to the administrative module to determine if data associated with the converted virtual cards meet the fraud and security elements as described above. For example, the reporting module may communicate with the administrative module in real-time to provide instantaneous updates in terms of use or activity of the virtual card in order to determine if potentially fraudulent activity is occurring. As another example, reporting module 1604 may be configured to receive reports from a reporting module of the virtual card engine 30 of a personal computing device.

In some embodiments, the virtual card manager may be configured to combine value data for two or more virtual cards. In this way, a user may consolidate a number of virtual cards included in the virtual card engine. The virtual card manager may also be configured to generate a second virtual value card and transfer a portion of the value data onto the second virtual card. In this way, a virtual card may be split. Example methods used to split the value of a virtual card and combine value cards are disclosed in U.S. application Ser. No. 12/562,091 filed Sep. 17, 2009 entitled SYSTEMS AND METHODS FOR MANAGING AND USING A VIRTUAL CARD, inventor David A. Nelson, and U.S. Provisional Application No. 61/354,113, filed Jun. 11, 2010, and titled SYSTEMS AND METHODS TO MANAGE AND CONTROL USE OF A VIRTUAL CARD, inventor David a. Nelson. The disclosures of which are hereby incorporated by reference for all purposes.

In some embodiments, geographical identifiers may be used to enhance the security of using a converted virtual card. Geographic identifiers for user mobile computing device are discussed in more detail in U.S. application Ser. No. 12/565,694 filed Sep. 23, 2009 entitled SYSTEMS AND METHODS FOR MANAGING A VIRTUAL CARD BASED ON GEOGRAPHICAL INFORMATION, inventor David A. Nelsen, the entire contents of which are hereby incorporated herein by reference for all purposes.

Briefly, in regards to use of the geographical identifiers, controls may be issued on a virtual card or a shared virtual card based on these geographical identifiers. These controls may be provided by the card service provider, the goods and services system or the user of the virtual card (or the shared virtual card or version in some systems). For example, a merchant may place controls or limitations based on geographical location information, a parent card holder may place limitations based on geographical location information, a government body may be the originator of limitations, etc. Whereas it is typical that usage limitations on stored value are typically managed at the goods and services system, the virtual card manager can also use the controls based on geographic location information. Non-limiting examples of controls based on geographic location information that may be used with the virtual card system: parent/child relationships, employee/employer relationships, government use of stored value, pharmaceutical and special use stored value, promotional card by merchant, etc.

Further, the virtual value account and the number of versions in the virtual value account may be determined by a user. For example, in FIG. 17, an example depiction of an example virtual card engine 30 from a user computing device is provided at 1700. As previously discussed, the virtual card engine may be stored on memory executable via at least one processor. Moreover, the virtual card engine may be executed on a computing device or a remote Internet server. In this way, a browser-based or client-based virtual card engine may be utilized.

The virtual card engine may include a virtual card toolbox 1700 having various modules that enable virtual value card management functions. The user and/or merchant may choose the module provided in the toolbox for each virtual card or virtual card type. In this way, the toolbox functionalities may be customized for one or more virtual cards or virtual card types.

Although different modules may be coupled to the virtual card toolbox, example modules include a conversion module 1710, sharing module 1712, a value modification module 1714, a graphical modification module 1716, a reporting module 1718, a media attachment module 1720, a password module 1722, and a shared settings module 1724. Further, although not illustrated, the modules may include a geo-comparative module with geographic identification data, a presentation module, etc. These modules are provided as example modules and are not intended to limit the scope of the disclosure in any way.

Each module may enable a user (or a merchant when used from the merchant end) to customize and manage a virtual card received by the user. Management of the virtual card may include options to convert a virtual card. In other examples, options may be provided to enable transfer or reassignment of a virtual card.

For example, conversion module 1710 may be configured to initiate the conversion of a fixed form card to a converted virtual card. For example, conversion module 1710 may provide an interface for a user to capture an image of a fixed form card for identification, as described above. Further, conversion module 1710 may be configured to communicate with virtual card manager 14 via an API, for example.

As another example, sharing module 1712 may be configured to enable sharing of a virtual card from the virtual card engine 30 to a selected second device creating a second version of the virtual card. Sharing of a virtual card may include authorizing the use of the second version of the virtual card while retaining some or all of the functionality of the first version (original) virtual card for use by the user. Use of a virtual card may include implementation of a virtual card transaction (e.g., exchanging goods and services for value data stored on a virtual card). It will be appreciated that various security features may be implemented during sharing to reduce the likelihood of fraudulent card use.

In addition to sharing module 1712, in some examples, the virtual card toolbox may include a value modification module 1714 configured to modify value data (e.g., increase or decrease) corresponding to a virtual card based on user input. The versions of the virtual card may be able, in some embodiments, to be treated as the original virtual card, such that the functionalities of the original virtual value card, may apply to the versions of the virtual value card. The value modification module may be further configured to send a request to an associated card service provider to modify value data in a corresponding provider-side associative card profile and/or the virtual card manager and the manager-side associative card profile. In some examples, value may be added to the virtual card from another virtual card and/or plastic card having value.

Further, in some embodiments, the value modification module may be adapted to enable minimum and maximum values that can be added to a virtual card. For example, 50 cents may be the minimum threshold value that may be added to a virtual card, due to the price of associated transaction charges. Increasing the value of a virtual card to a maximum value may be referred to as “topping off” the virtual card. Further in some embodiments, incentives may be provided by the card service provider or the merchant to increase the value of a virtual card. For example, a promotional card, virtual coupon, etc., may be offered to a user when the value of a virtual card is increased to meet or exceed a threshold value determined by the merchant or card service provider.

Further in some examples, value modification module 1714 may be configured to combine value data for two or more virtual cards. In this way, a user may consolidate a number of virtual cards included in the virtual card engine. Value modification module 414 may also be configured to generate a second virtual value card and transfer a portion of the value data onto the second virtual card. In this way, a virtual card may be split. Example methods used to split the value of a virtual card and combine value cards are disclosed in U.S. application Ser. No. 12/562,091 filed Sep. 17, 2009 entitled SYSTEMS AND METHODS FOR MANAGING AND USING A VIRTUAL CARD, inventor David A. Nelson. The disclosures of which are hereby incorporated by reference for all purposes.

The virtual card toolbox may further include additional modification modules, such as example graphical modification module 1716. Graphical modification module 1716 may enable user customization of a virtual card. Although, the graphical modification module 1716 may be available to versions of a shared virtual card, in some examples the module may be turned off or features limited.

As an example, the graphical modification module 1716 may be adapted to enable a user to modify the appearance of a portion or associated image of at least one virtual card presented on a display of a computing device. The appearance of the virtual card may include at least one of size, color, geometric configuration, and graphical characteristics (e.g. alpha-numeric data, images, logos, etc.). In some examples, modifying the appearance of a virtual card may include modifying an alphanumeric greeting presented directly on the virtual card or presented in a separate window when a virtual card is accessed. In this way, a user may customize and personalize the virtual card for a target recipient, thereby increasing customer satisfaction.

The virtual card toolbox may further include one or more reporting modules or status modules, such as reporting module 1718. Reporting module 1718 may enable a user to report a status of a virtual card, such as a “lost/stolen” status. The lost/stolen status may be a result of error in reassigning the virtual card (such as to the wrong recipient). In other examples, lost/stolen status may be a result of losing a printed virtual card or deleting the virtual card or version of a virtual card.

In some examples, a “lost/stolen” call may be sent to a virtual card manager and forwarded to a card service provider in response to user input indicating that a virtual card may be lost or stolen. For example, reporting module 1718 may send a status reporting indicating that the virtual card is “lost/stolen” to the reporting module 1604 of the virtual card manager, as described above. However, in other examples, the lost/stolen call may be sent directly to the card service provider. In response to the “lost/stolen” call, the card service provider may reissue a new virtual card to the virtual card engine. In some examples, re-issuing a new card may include generating a new manager-side and provider-side virtual card profile as well as generating a new virtual card and sending the new virtual card to the virtual card engine. In other examples, re-issuing a new virtual card may include redeeming the virtual card's stored value and transferring the stored value to a new provider-side associative card profile having a new identification number and/or PIN. It will be appreciated that different card service providers may have different responses to a “lost/stolen” call based on the capabilities of the card service provider. Further, in some embodiments, a report including information pertaining to the movement of monetary value in the card service provider may be sent to the merchant in response to the “lost/stolen” call. Further still, in some embodiments, the virtual card manager may disable and/or deactivate the virtual card when a “lost/stolen” call is received. In this way, a user may inhibit unauthorized use of a virtual card if they suspect that unauthorized use may occur. For example, a printed copy of a virtual card may be misplaced or possibly stolen. Therefore, a user may choose to report a virtual card “lost/stolen”. In some examples, the user may be charged for each use of the reporting module, discouraging unnecessary use. It will be appreciated that the reporting module may provide additional security against fraudulent use of a virtual card.

The virtual card toolbox may further include a media attachment module 1720 configured to attach audio and/or video clips or game clips to a virtual card or one or more versions of the virtual card. In some examples, the audio or video clips may be presented directly on a displayed image of the virtual card. However in other examples, the audio and/or video clips may be presented in a separate window when a virtual card is accessed. The user may selectively attach such audio or video clips to customize the virtual card to a target recipient. In some embodiments, the target recipient may be able to replay such audio and/or video clips. In some examples, the media attachment modules may be limited or unavailable for some versions of a virtual card depending on a user's selection, the manager's selection, etc.

The virtual card toolbox may also include enhanced security modules, such as a password module 1722. Password module may be configured to require a user to enter a password to gain access to the virtual card engine. It will be appreciated that in some embodiments, a user may selectively activate the password module. Alternatively, the password may be determined by the user of the virtual card engine. The password adds another level of security to prevent unauthorized use of a virtual card. The consumer controlled password may enable a user comfort that transfer or re-gifting can only occur through their initiation. In some examples, the password may be independent of a virtual card's PIN or other code. By providing this additional user password, additional security may be obtained such as in an open loop card system where the card can be used at a plurality of locations and may be more difficult to monitor. It should be appreciated that in some systems, each version of a shared virtual card may have a different password or be selectively set for the specific version. In other examples, a password or pin may be shared between the versions for a single virtual card account.

It will be appreciated that the functionalities of the modules included in the virtual card toolbox may be implemented together in a single step. As such, various functionalities may be packaged with the sharing process. For example, the functionalities described with regard to the value modification module, the graphical modification module, the reporting module, and the media attachment module may be carried out directly prior to or during sharing of a virtual card. In this way, various aspects of the virtual card may be customized by a user when a virtual card is shared, thus enabling a user to personalize a version of a virtual card for the intended recipient. After sharing is initiated the user may be prompted by the virtual card engine to alter various aspects of the virtual card such as the password, the card's appearance, audio, and/or video attached to the card, etc.

Returning again to the illustrated modules in FIG. 17, the virtual card engine may further include a sharing settings module 1724 including a plurality of virtual card sharing settings 1726. The sharing settings may allow a user (or a merchant) to selectively enable or disable the virtual card functions (e.g., toolbox functions) that may be available to a virtual card engine to adjust various aspects of the virtual card version. In this way, the toolbox functions may be controlled depending on the version of the card. For example, a user may choose to inhibit reassignment of a shared virtual card. In another example, a user may choose to allow the appearance of a shared virtual card from being altered.

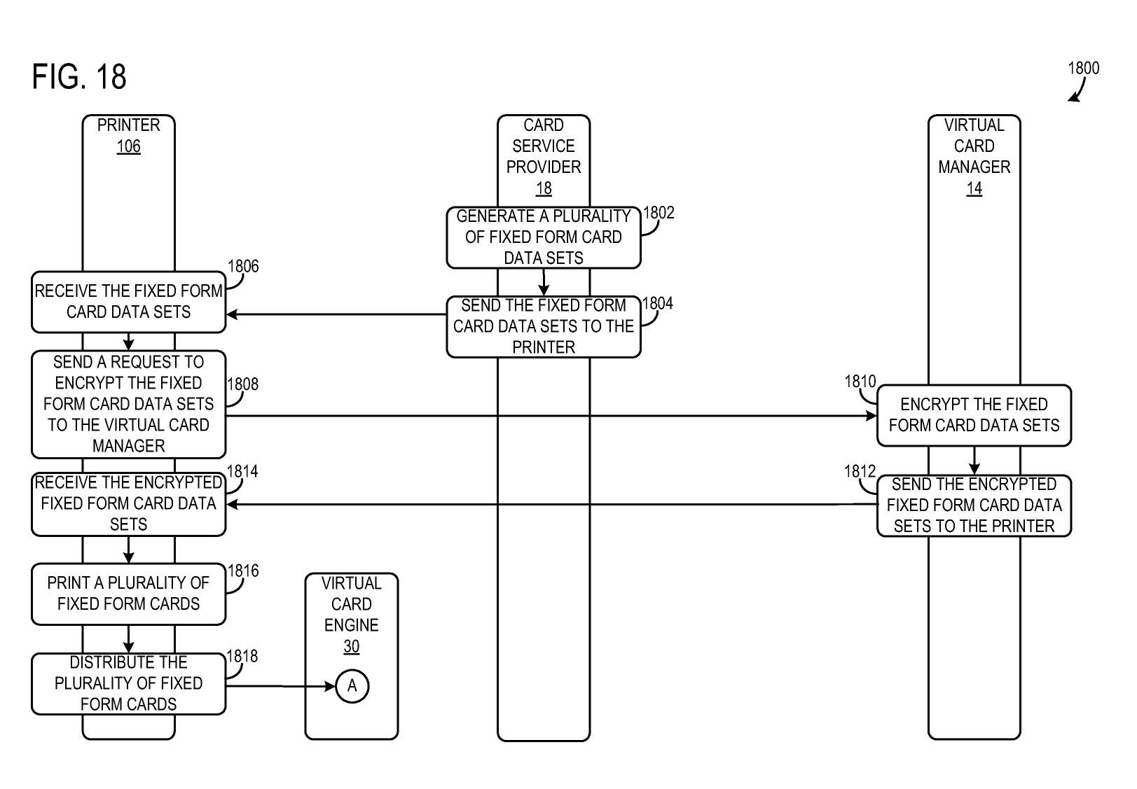

FIGS. 18-20 show a method 1800 for converting a fixed form card to a virtual card. Method 1800 is shown being implemented by the virtual card management system 10 including the virtual card engine 30, virtual card manager 14, goods and services system 16, card service provider 18, and printer 106, depicted in FIG. 1. However, it will be appreciated that method 1800 may be implemented by another suitable virtual card management system.

At 1802 the method includes, at the card service provider 18, generating a plurality of fixed form card data sets. It will be appreciated that generating a plurality of fixed form card data sets may include generating a plurality of provider-side fixed form card profiles. Additionally, generating a plurality of fixed form card data sets may include generating a plurality of manager-side fixed form card profiles. The fixed form card profiles (e.g., manager-side and provider-side fixed form card profiles) may include identification data, barcode data (e.g., a two-dimensional barcode), and/or value data.

At 1804 the method includes, at the card service provider 18, sending the fixed form card data sets to the printer 106. At 1806 the method includes, at the printer 106, receiving the fixed form card data sets. At 1808 the method includes, at the printer 106, sending a request to encrypt the fixed form card data sets to the virtual card manager 14. However, in other embodiments the request to encrypt the fixed form card data sets may be sent to the card service provider 18 and/or the goods and services system 16, shown in FIG. 1.

At 1810 the method includes, at the virtual card manager 14, receiving the encryption request and in response encrypting the fixed form card data sets. However, in other embodiments, the card service provider 18 and/or the goods and services system 16 may encrypt the fixed form card data sets. At 1812 the method includes, at the virtual card manager 14, sending the encrypted fixed form card data sets to the printer.

At 1814 the method includes, at the printer 106, receiving the encrypted fixed form card data sets. At 1816 the method includes, at the printer 106, printing a plurality of fixed form cards. Each of the fixed form cards may include a barcode (e.g., two-dimensional barcode), a personal identification number (PIN), a magnetic strip, image data, etc.

At 1818 the method includes distributing the plurality of fixed form cards. The fixed form card may be distributed through the various processes previously discussed. Thus, a fixed form card may be distributed to a user of the computing device 12.

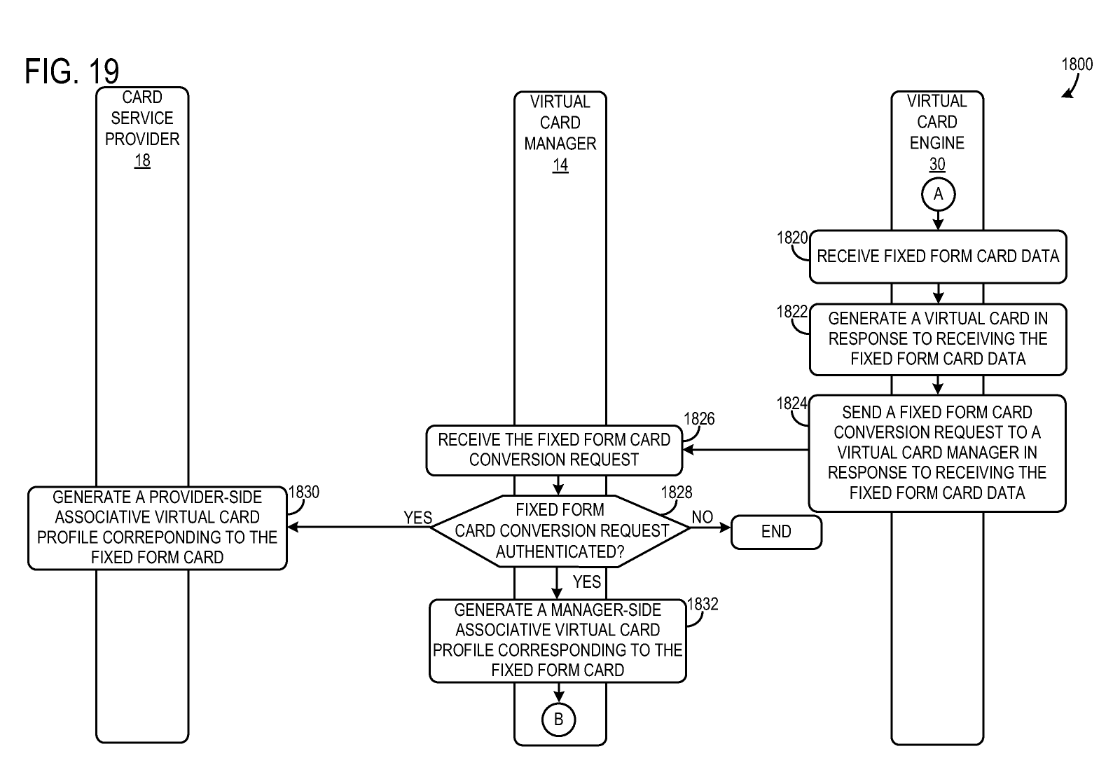

In FIG. 19 the method includes at 1820, at the virtual card engine 30, receiving fixed form card data. The fixed form card data may include an image of a barcode, such as a two-dimensional barcode. Specifically, in some examples receiving fixed form card data includes receiving image data from a camera integrated into or otherwise coupled to the user computing device 12. Additionally receiving fixed form card data may include receiving a PIN from an input device (e.g., keyboard) integrated or otherwise coupled to the user computing device 12, shown in FIG. 1. In some examples, a user may be prompted to enter the PIN via the virtual card manager 14. In this way, the security of the card conversion may be increased, thereby reducing the likelihood of fraudulent conversion. The fixed form card data may also include additional card image data and designation data (e.g., identification numbers, symbols, etc.) corresponding to the fixed form card.

Continuing with FIG. 19, at 1822 the method includes, at the virtual card engine 30, generating a virtual card in response to receiving the fixed form card data. Thus, generating a virtual card may include generating a file in the virtual card engine. Furthermore, generating a virtual card may include generating virtual card data including at least one of card image data, barcode data, and designation data corresponding to the fixed form card.

At 1824 the method includes, at the virtual card engine 30, sending a fixed form card conversion request to the virtual card manager 14 in response to receiving the fixed form card data. The fixed form card conversion request includes at least a portion of the fixed form card data received by the virtual card engine 30. Specifically, the fixed form card conversion request may include the PIN number included in the fixed form card data and/or barcode data (e.g., a two-dimensional barcode) included in the fixed form card data. However, in some examples, the virtual card manager may send a PIN request to the virtual card engine. In response, the virtual card engine may send a PIN back to the virtual card manager. The PIN may be entered into the virtual card engine by a user, in some embodiments.

At 1826 the method includes, at the virtual card manager 14, receiving the fixed form card conversion request. At 1828 the method includes, at the virtual card manager 14, determining if the fixed form card conversion request can be authentication. It will be appreciated that authentication may be determined based on a comparison of data in the barcode or other fixed form code (e.g. the two-dimensional barcode) in the fixed form card conversion request with data stored in the virtual card manager 14 and/or the card service provider 18 associated with the fixed form card. In some examples, the data in the fixed form code, such as the bar-code, may be obtained from decryption of the barcode. As an example, if data in or associated with the barcode (e.g., two-dimensional barcode) matches data associated with the fixed form card stored in the virtual card manager 14 and/or the card service provider 18 the fixed form card conversion request is authenticated. However, if the data in the barcode does not match the data associated with the fixed form card stored in the virtual card manager 14 and/or the card service provider 18 then the fixed form card conversion request is not authenticated. It will be appreciated that the data associated with the fixed form card may be stored in a manager-side and/or provider-side associative fixed form card profile. Furthermore, the barcode as well as other fixed form card data included in the conversion request may be encrypted. Therefore, the barcode may be decrypted prior to or during authentication.

As another example, authentication of the fixed form card conversion request may include determining if a PIN (or other personal code) included in the fixed form card conversion request matches a PIN stored in the virtual card manager 14 and/or the card service provider 18, the PIN associated with the fixed form card. If the two PINs match and/or the data in the barcode matches the stored data associated with the fixed form card then the fixed form card conversion request may be authenticated. However, if the two PINs match and/or the data in the barcode does not match the stored data associated with the fixed form card then the fixed form card conversion request may not be authenticated. The PIN may be stored in a manager-side and/or provider-side associative fixed form card profile. In this way, conversion security may be increased, thereby reducing the likelihood of fraudulent conversion.

If the fixed form card conversion request cannot be authenticated (NO at 1828), the method ends. However, if the fixed form card conversion request is authentication (YES at 1828) the method includes at 1830, at the card service provider 18, generating a provider-side associative card profile corresponding to the fixed form card. The provider-side associative virtual card profile may include value data, identification data (PIN, identification code(s), identification numbers, etc.), image data, etc. Specifically, in some examples, the provider-side associative fixed form card profile may be changed to a provider-side associative virtual card profile. The virtual card profile may have additional functionality such as selective enablement, periodic authentication, etc. Further still in some embodiments, data (e.g., value data, identification data) from the provider-side associative fixed form card profile may be transferred to a provider-side associative virtual card profile and the provider-side associative fixed form car profile may be subsequently deleted.

Additionally, step 1832 may also be implemented if the fixed form card conversion request is authenticated (YES at 1828). Step 1832 includes generating a manager-side associative virtual card profile corresponding to the fixed form card. The manager-side associative virtual card profile may include value data, identification data, and/or image data. In some examples, data (e.g., value data, identification data) may be transferred from a provider-side or manager-side associative fixed form card profile to the manager-side associative virtual card profile while generating the manager-side associative virtual card profile. Thus, the value data from the provider-side associative fixed form card profile may be requested by the virtual card manager.

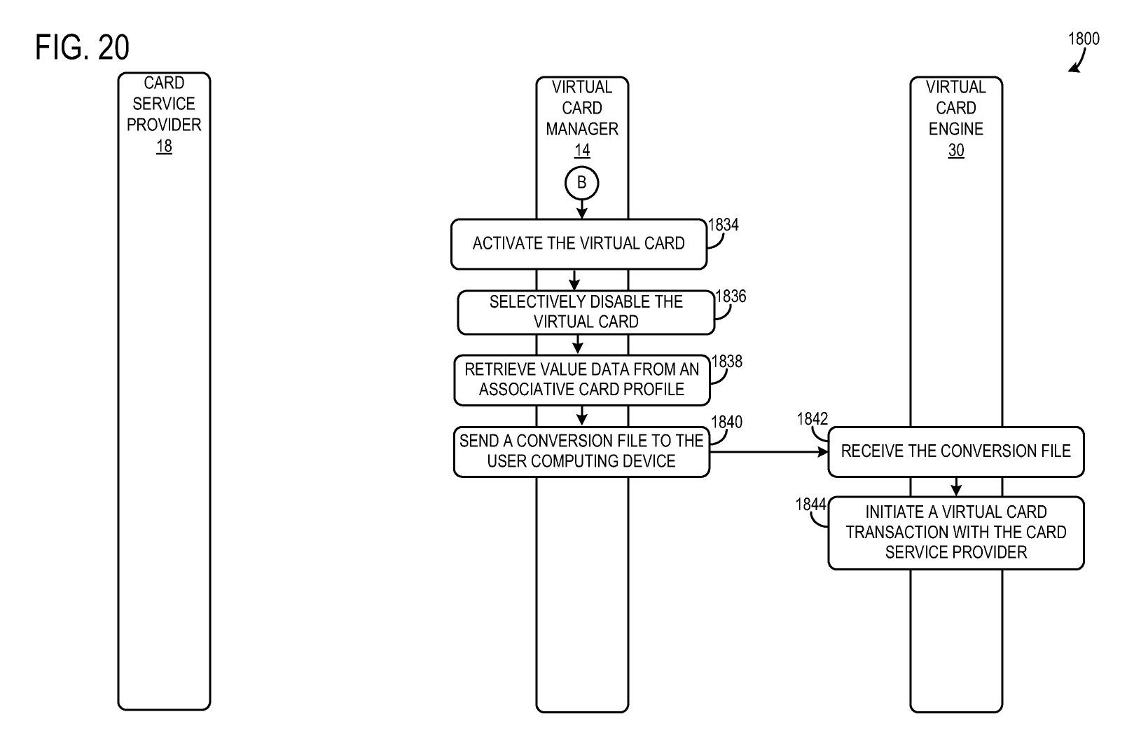

In FIG. 20 at 1834 the method includes, at the virtual card manager 14, activating the virtual card at the virtual card manager. Next at 1836 the method includes, at the virtual card manager 14, selectively disabling the virtual card. In this way, the likelihood of fraudulent use of the virtual card is reduced. However, in other examples, the method may include selectively enabling the virtual card or step 1836 may not be included in the method 1800. At 1838, the method includes, at the virtual card manager 14, retrieving value data from an associative card profile such as the manager-side associative fixed form card profile, the provider-side associative fixed form card profile, the manager-side associative virtual card profile, and/or the provider-side associative virtual card profile.

At 1840, the method includes, at the virtual card manager 14, sending a conversion file to the virtual card engine 30. The conversion file may include the value data corresponding to the fixed form card, among other things. Specifically, the value data in the conversion file may be identical to the value data associated with the fixed form card. Moreover, the conversion file may be encrypted to increase security. In some examples, advertisements may be included in the conversion file. In this way, additional revenue may be generated by the system.

At 1842 the method includes, at the virtual card engine 30, receiving the conversion file. After the conversion file is received by the virtual card manager the value data in the conversion file may be transferred to the virtual card.

At 1844 the method includes, at the virtual card engine 30, initiating a virtual card transaction with the card service provider 18 and/or the goods and services system 16, shown in FIG. 1. In some embodiments, the virtual card engine 30 is configured to display an image of the virtual card including a two-dimensional barcode during a virtual card transaction.

The systems and methods described herein allow a user to easily and securely convert a fixed form plastic card to a virtual card. The converted virtual card may be tracked through a virtual card manager corresponding to a single stored value account from the card service provider. Security features and controls may be provided to the converted virtual cards. Further, systems and methods may be applied to ensure tracking of the converted virtual card. Moreover, in some embodiments, systems and methods which use geographic identifiers may be used to further enable control functions for a converted virtual card and/or any virtual card or versions thereof.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein.

Inventions embodied in various combinations and subcombinations of features, functions, elements, and/or properties may be claimed in a related application. Such claims, whether they are directed to a different invention or directed to the same invention, whether different, broader, narrower or equal in scope to any original claims, are also regarded as included within the subject matter of the inventions of the present disclosure.

1. A system for converting a fixed form card to a virtual card, the system comprising:
a user computing device including a mass storage executable by a processor and having a virtual card engine stored thereon,
the virtual card engine configured to receive fixed form card data, generate a virtual card in response to receiving the fixed form card data, send a fixed form card conversion request to a virtual card manager in response to receiving the fixed form card data, receive a conversion file including virtual card value data corresponding to the value of the fixed form card from the virtual card manager upon authentication of the fixed form card data via the virtual card manager, and initiate a virtual card transaction with a card service provider.

2. The system of claim 1, where receiving fixed form card data includes receiving image data from a camera included in the user computing device.

3. The system of claim 1, where the fixed form card is a fixed form gift card and where the virtual card is a virtual gift card, where the virtual card value data is identical to fixed form card value data stored in the card service provider.

4. The system of claim 3, where the fixed form card value data is stored in a provider-side associative fixed form card profile in the card service provider.

5. The system of claim 1, where the virtual card engine is configured to send a personal identification number (PIN) associated with the fixed form card to the virtual card manager and where the virtual card manager determines if the PIN matches a second PIN associated with the fixed form card stored in the virtual card manager to authenticate the fixed form card.

6. The system of claim 1, where generating the virtual card including generating virtual card data including at least one of card image data, barcode data, and designation data corresponding to the fixed form card.

7. The system of claim 1, where in response to authentication of the virtual card via the virtual card manager activating the virtual card.

8. The system of claim 1, where the fixed form card data is encrypted and where the virtual card manager is configured to decrypt the encrypted fixed form card data during authentication.

9. The system of claim 1, where the fixed form card data includes a two-dimensional barcode.

10. The system of claim 1, where the card service provider is configured to manage fixed form card services and virtual card services.

11. The system of claim 1, where the virtual card engine is configured to display the virtual card during a virtual card transaction.

12. A method for converting a fixed form card to a virtual card, the method comprising:
at a virtual card manager, receiving a fixed form card conversion request including fixed form card data from a virtual card engine executed via a virtual card engine executed on a user computing device; and
if the fixed form card data is authenticated, sending a conversion file including value data associated with the fixed form card to the virtual card engine.

13. The method of claim 12, further comprising if the fixed form card data is authenticated activating a virtual card at the virtual card manager.

14. The method of claim 12, further comprising if the fixed form card data is authenticated activating a virtual card at the virtual card manager.

15. The method of claim 12, further comprising, at the virtual card manager, sending a personal identification number (PIN) request to the virtual card engine prior to authenticating the fixed form card and where authenticating the fixed form card data including determining if a PIN received from the virtual card engine matches a second PIN included in a manager-side associative fixed form card profile stored in a card service provider.

16. The method of claim 12, where the fixed form card data includes a two-dimensional barcode and authenticating the fixed form card data includes decrypting the two-dimensional barcode and determining if data in the decrypted two-dimensional bar code matches data stored in the virtual card manager and associated with the fixed form card.

17. The method of claim 12, further comprising at the virtual card manager, generating a manager-side associative virtual card profile and receiving value data from a provider-side associative fixed form card profile in a card service provider prior to sending the conversion file.

18. A method for converting a fixed form gift card to a virtual gift card, the method comprising:
at a virtual card engine executed on a user computing device, receiving image data of a two-dimensional barcode on the fixed form gift card from a camera integrated into the user computing device;
generating a virtual gift card in response to receiving the image data of the two-dimensional barcode;
sending a fixed form gift card conversion request including the two-dimensional barcode to a virtual card manager in response to receiving the two-dimensional barcode;
at a virtual card manager, receiving the fixed form card conversion request; and
if data in the two-dimensional barcode matches data associated with the fixed form gift card stored in the virtual card manager, sending an encrypted conversion file including value data associated with the fixed form gift card to the virtual card engine.

19. The method of claim 18, further comprising at the virtual card manager, if the two-dimensional barcode is authenticated activating a virtual card.

20. The method of claim 18, further comprising, at the virtual card manager, sending a personal identification number (PIN) request to the virtual card engine prior to authenticating the fixed form card and where authenticating the fixed form card data including determining if a PIN received from the virtual card engine matches a second PIN included in a manager-side associative fixed form card profile stored in a card service provider.
